(19) United States
(12) Patent Application Publication
(10) Pub. No.: US 2006/0103163 A1
(43) Pub. Date: May 18, 2006

(54) Motor vehicle body comprising a strut arrangement

(76) Inventors: Stephan Rech-Linker, Aidlingen (DE); Matthias Scheffzuek, Tuebingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/521,436

(22) PCT Filed: Jun. 4, 2003
(86) PCT No.: PCT/EP03/05831

§ 371 Date: Sep. 16, 2005

(30) Foreign Application Priority Data
Jul. 17, 2002 (DE) 102 32 329.1

(51) Int. Cl. B62D 25/08

(52) U.S. Cl. 296/96.15

(57) ABSTRACT

To increase the flexural and torsional strength of the fore-part structure, a motor vehicle body has a strut arrangement for supporting a component of the fore-part structure on a crossmember running underneath the windshield. To assume further functions, a length region of a strut arrangement has at least one fastening point of a windshield wiping system.

### BACKGROUND AND SUMMARY OF THE INVENTION

This invention relates to a motor vehicle body.

A body of a motor vehicle comprising a strut arrangement may be gathered as known from Japanese document JP 11115812 A, in which a spring strut dome of a fore-part structure is supported on a cross member arranged underneath a windshield. The strut arrangement in this case comprises a fastening point at which various vehicle components, for example the windshield wiping system, are to be fastened.

A windshield wiping system may be gathered as known from British document GB 2 258 145 A, which is fastened to a bearer of a motor vehicle body via a damping element.

Finally, a motor vehicle body may already be gathered as known from German document DE 199 28 588 A1, in which a strut arrangement having two struts is provided for increasing the flexural and torsional strength of the body. The two struts are supported at one end on a crossmember running underneath the windshield and at the other end on a respectively assigned component of the fore-part structure of the body.

The object on which the invention is based is to provide a motor vehicle body of the type initially mentioned, the strut arrangement of which is designed to assume further functions.

The solution according to the invention for achieving this object arises from the features of the main claim.

Advantageous refinements of the invention may be gathered from the remaining claims.

In a motor vehicle body according to the invention, the strut arrangement, in addition to increasing flexural and torsional strength of the body, has the further function of being capable of receiving or carrying components of a windshield wiping system. For this purpose, at least one length region of this strut arrangement has at least one fastening point, at which the components of the windshield wiping system can be arranged. The measures according to the invention make it possible that, for example, the arrangement of a separate bracket for the windshield wiping system on the body may be dispensed with. Moreover, integration can solve the frequent problem of arranging components of the windshield wiping system ideally in a region in which the strut arrangement runs.

Further advantages, features and details of the invention may be gathered from the following description of a preferred exemplary embodiment and with reference to the drawings.

### BRIEF DESCRIPTION OF THE DRAWINGS

FIG. 1 shows a partial perspective view of that region of the fore-part structure which is at front left in the direction of travel, with a strut arrangement of the motor vehicle body according to the invention;

FIG. 2 shows an enlarged top view of the front left region of the fore-part structure according to FIG. 1 with a strut arrangement according to the invention;

FIG. 3 shows an enlarged perspective view of the front left region of the fore-part structure according to FIGS. 1 and 2 with a strut arrangement according to the invention; and

FIG. 4 shows a perspective bottom view of the strut arrangement according to the invention in the front left region of the fore-part structure according to FIGS. 1 to 3.

### DETAILED DESCRIPTION OF THE INVENTION

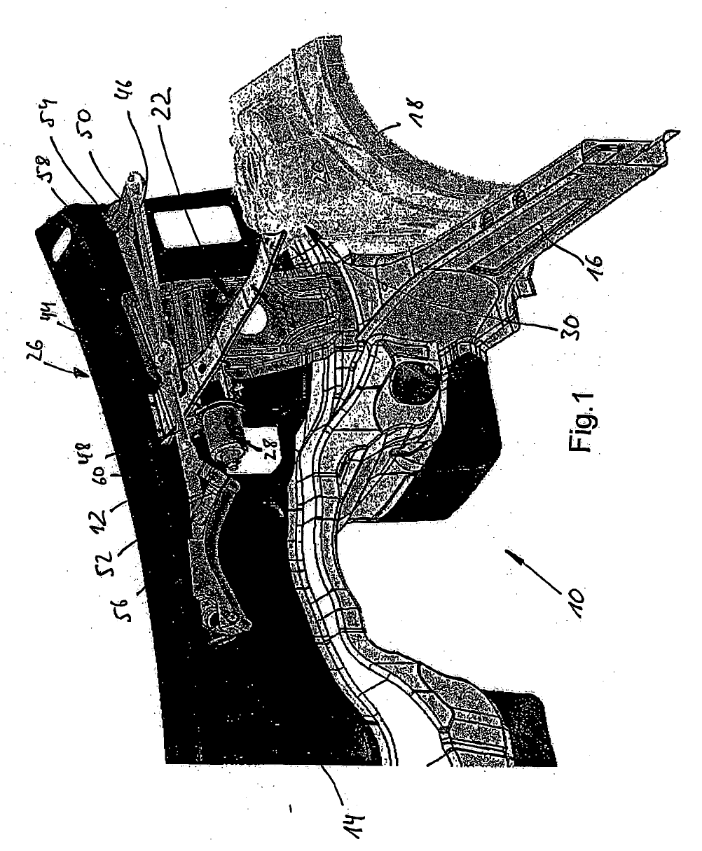

FIG. 1 illustrates a partial perspective view of that region of the fore-part structure 10 of a motor vehicle body which is at front left in the direction of travel. The fore-part structure 10 comprises essentially a crossmember 12 which runs underneath the windshield, not shown, and which delimits upwardly a front end wall 14 of the motor vehicle. What is also illustrated of the fore-part structure 10 is a part portion of the left side member 16, on the outside of which is arranged a wheel housing plate 18 designed as a bearer. A spring strut dome 20 rises from the wheel housing plate 18 on the top side and serves for receiving a spring strut or similar spring and/or damper element, not shown, which is welded to the wheel housing plate 18 along a continuous seam. To increase the flexural and torsional strength of the motor body during the introduction of chassis forces into the fore-part structure 10 via the spring strut dome 20, the spring strut dome 20 is supported in a way explained in more detail below by means of the strut arrangement 22 on the crossmember 12 running underneath the windshield. It is clear that the crossmember 12 does not need to run directly underneath the windshield. Moreover, the strut arrangement 22 may also be supported on another component of the fore-part structure 10, instead of on the spring strut dome 20. The strut arrangement 22 is formed here by a strut 24; it is, however, likewise also conceivable for further struts to form the strut arrangement 22. A fastening point for a wiper drive 28 of a windshield wiping system 26 is provided on a length region of the strut 24 in a way explained in more detail below.

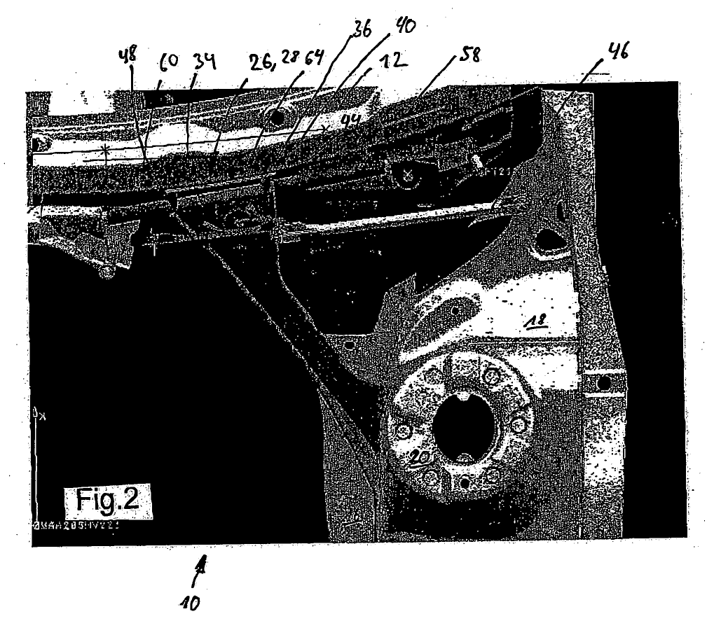

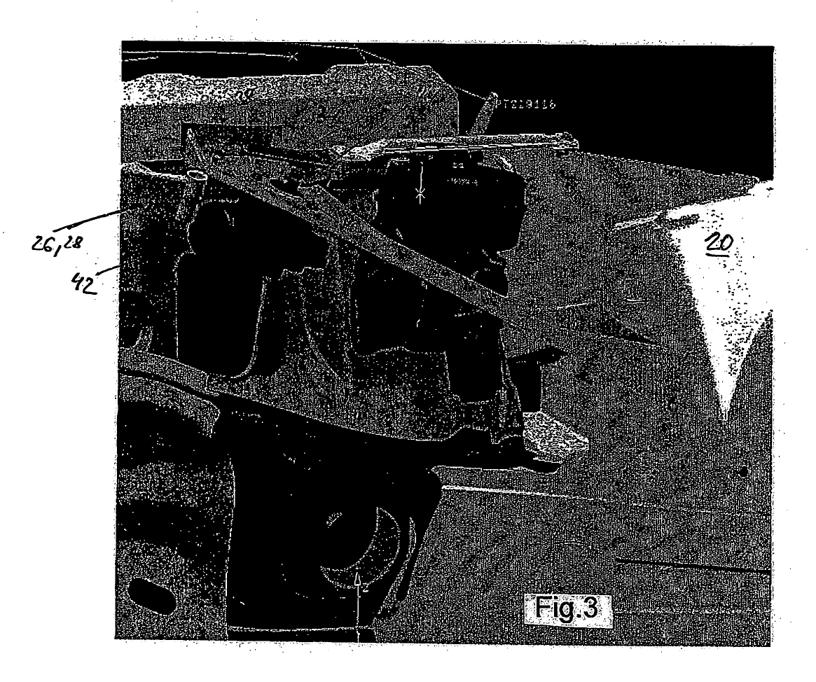

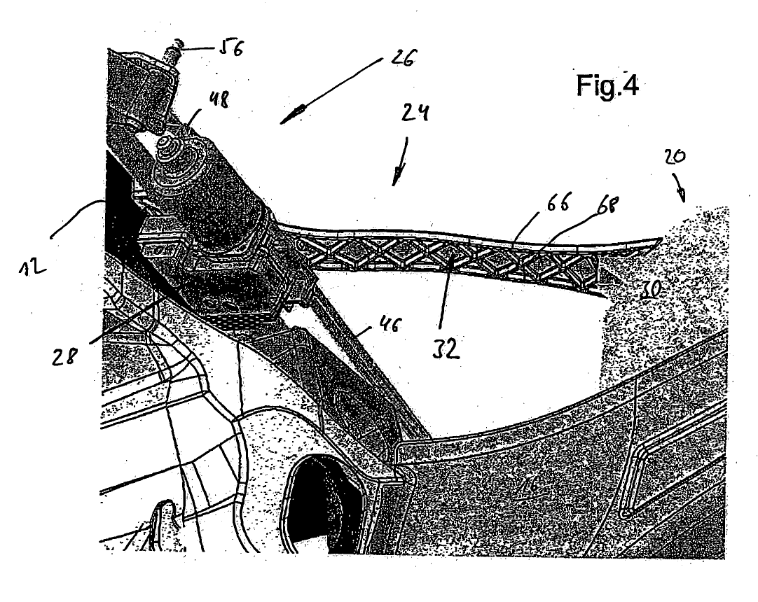

FIG. 2 shows an enlarged top view of the strut 24 in the front left region of the fore-part structure 10, said strut being fastened with one end to the inside 30, facing the vehicle center, of the spring strut dome 20 and with its other end to an approximately vertical front side of the crossmember 12. In a comparison with FIGS. 3 and 4 which illustrate strut 24 in an enlarged perspective view and in a perspective bottom view respectively, it becomes clear that the wiper drive 28 is arranged on an end region facing the crossmember 12 and on the underside 32 (FIG. 4) of the strut 24. For this purpose, the strut 24 has, over a length portion, a bracket 34 (FIG. 3) from which a passage bore 36 is cut out. The wiper drive 28 is secured to the strut 24 here via three screw connections 28. A drive shaft 40 of a drive motor 42 of the wiper drive 28 passes through the strut 24 via the passage bore 36. The drive shaft 40 has slipped onto it a crank 44, via which a left driving arm 46 and a right driving arm 48, as seen in the direction of travel, can be jointly operated. At the end respectively facing away from the bearing point between the driving arms 46, 48 and the crank 44, the driving arms 46, 48 are connected in an articulated manner to a respectively assigned link 50, 52. The links 50, 52 form in each case tenon-like bearing points 54, 56 onto which the assigned windshield wiper can be slipped and about which the latter can be rotated. In this case, the two bearing points 54, 56 of the windshield wipers are carried in each case by a holding arm 58, 60 projecting laterally from the strut 24, for which purpose tenons 62 (FIG. 2) aligned with the bearing points 54, 56 are provided on the holding arms 58, 60, a respectively assigned link 50, 52 being capable of being slipped onto said tenons. The two holding arms 58, 60 are designed here as a one-part rod and are held on the strut 24 within a tubular receptacle, the holding arm 58, 60 or the rod being adjustable conversely to the strut 24.

In order, for example, to avoid an introduction of vibrations of the drive motor 42 of the wiper drive 28 into the body, the strut 24 may be supported on the spring strut dome 20 and on the crossmember 12 via a damping element, not shown. The wiper drive 28 may likewise be fastened to the strut 24 via a damping element. The strut 24 has here essentially a flat cross section which widens in the region of the supporting point on the spring strut dome 20 and on the cross member 12. Webs 66 (FIG. 4) increasing the flexural and torsional strength of the strut 24 are provided here on the edge side. Moreover, for this purpose, framework-like further webs 68 are provided on the underside 32 of the strut 24.

1-10. (canceled)

11. A motor vehicle body comprising a strut arrangement for supporting a component of a fore-part structure on a crossmember running underneath a windshield, the strut arrangement comprising a strut, via which a spring strut dome of the fore-part structure is supported on the crossmember, the strut of the strut arrangement having at least one fastening point of a wiper drive of a windshield wiping system wherein the wiper drive is arranged on an underside of the strut, and a drive shaft of the wiper drive passes through the strut.

12. The motor vehicle body as claimed in claim 11, wherein the wiper drive is fastened to an end region, facing the crossmember, of the strut.

13. The motor vehicle body as claimed in claim 11, wherein the strut is fastened to an inside, facing the vehicle center, of the spring strut dome.

14. The motor vehicle body as claimed in claim 11, wherein a bearing point of a windshield wiper of the windshield wiping system is held by the strut arrangement.

15. The motor vehicle body as claimed in claim 14, wherein the bearing point of the windshield wiper is carried by a holding arm which projects laterally from the strut.

16. The motor vehicle body as claimed in claim 11, wherein the strut is supported on the spring strut dome and on the crossmember via a damping element.

17. The motor vehicle body as claimed in claim 11, wherein the wiper drive is fastened to the strut via a damping element.
